(19) United States
(12) Patent Application Publication
(10) Pub. No.: US 2026/0339647 A1
(43) Pub. Date: Oct. 29, 2026

(54) FUNCTIONALITY CUSTOMIZATION FOR AGENTIC AGENTS

(71) Applicant: Dell Products L.P., Round Rock, TX (US)

(72) Inventors: OFIR EZRIELEV, Be'er Sheva (IL); YEHIEL ZOHAR, Sderot (IL); HANNA YEHUDA, Acton, MA (US)

(21) Appl. No.: 19/192,601

(22) Filed: Apr. 29, 2025

(51) Int. Cl. G06F 8/65

(52) U.S. Cl. CPC G06F 8/65

(57) ABSTRACT

Methods and systems for managing operation of infrastructure are provided. To manage the infrastructure, agentic agents may be deployed. The deployed agentic agents may be customized prior to deployment. The agentic agents may be customized with respect to some software functionalities. The agentic agents may interact with users of the infrastructure via a chat or other type of interface to attempt to infer intents of the users with respect to computer implemented services provided by the infrastructure. The intent may be used by the agentic agents to manage the infrastructure.

### FIELD

Embodiments disclosed herein relate generally to infrastructure. More particularly, embodiments disclosed herein relate to systems and methods to manage infrastructure using agentic agents.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIGS. 1B-2D show data flow diagrams illustrating processing and use of data in accordance with an embodiment.

FIGS. 3A-3C show flow diagrams illustrating methods in accordance with an embodiment.

FIG. 4 shows a block diagram illustrating a data processing system in accordance with an embodiment.

### DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of infrastructure. To manage the infrastructure, agentic agents may be deployed and tasked with managing the infrastructure to effectuate the desired intents of users of the infrastructure.

The agentic agents may be customized for different domains. Once customized, users may initiate communications with the agentic agents using a chat interface. The chat interface may be used to convey the intents to the agentic agents. Different agentic agents may be customized to different domains and, therefore, may have access to different types of information, reasoning processes, etc. Accordingly, the agentic agents may generate different responses to chats by the users.

The chat interface may be used to obtain information regarding intents of the user, confirm the intents of the users, and/or align future management activities of the agentic agents with the user intents.

By doing so, embodiments disclosed herein may improve the likelihood of services provided by infrastructure being deemed to be desirable by the users. Thus, embodiments discussed herein may address, among others, the technical problem of intent and expectation mismatch between users of infrastructure and the managers of the infrastructure.

In an embodiment, a method for managing infrastructure that provides desired computer implemented services is provided. The method may include identifying an occurrence of an agent instantiation event for the infrastructure; based on the occurrence: obtaining agent data based on the occurrence, the agent data indicating at least a system domain and a logical domain; identifying, using at least in part the agent data, a functionality of a software component; dynamically generating, using at least in part software development artifacts for the software component, new documentation; updating operation of a pre-trained agentic agent using at least the new documentation to obtain a functionality customized agentic agent; and deploying the functionality customized agentic agent to manage, in part, operation of a portion of the infrastructure to facilitate continued provision of the desired computer implemented services.

The method may also include discriminating a first portion of data assets from other portions of the data assets based on, at least, the system domain and the logical domain; and updating operation of the functionality customized agentic agent using the first portion of the data assets so that the deployed functionality customized agentic agent is also customized to the system domain and the logical domain.

The functionality of the software component may also identified based on the first portion of the data assets.

Identifying the functionality of the software component may include identifying an information content deficiency in the first portion of the data assets relative to the system domain and the logical domain; and searching functionalities of software components to identify that the functionality of the software component is usable to remediate, at least in part, the information content deficiency.

The functionality of the software component may also identified using associations between the logical domain and/or the system domain to different software components, the software component being one of the different software components.

The software development artifacts may include at least one selected from a list consisting of: software development goal information; production code for the software;
code development organizational information; test code used to test the software;
test plans defining how the software is to be tested; artifacts produced during testing of the software using the test code and the test plans; and software product integrated organizational information.

Updating the operation of the pre-trained agentic agent using at least the new documentation to obtain the functionality customized agentic agent may include fine-tuning a generative trained machine learning model of the pre-trained agentic agent using the new documentation.

Updating the operation of the pre-trained agentic agent using at least the new documentation to obtain the functionality customized agentic agent may include fine-tuning a reasoning model of the pre-trained agentic agent using the new documentation.

Updating the operation of the pre-trained agentic agent using at least the new documentation to obtain the functionality customized agentic agent may include populating a data source of the pre-trained agentic agent using the new documentation, the data source used for contextual information retrieval.

Deploying the functionality customized agentic agent may include instantiating an instance of the functionality customized agentic agent; operably connecting the instance to a control plane for the portion of the infrastructure to facilitate modification of the operation of the portion of the infrastructure by the instance; and placing the instance in a discoverable state by a facilitator.

The facilitator may be adapted to establish chat based interface sessions for clients with authority to manage the operation of the portion of the infrastructure and selectively integrate functionality customized agentic agents into the established chat based interface sessions.

The facilitator may be further adapted to moderate conversation between the clients and the selectively integrated functionality customized agentic agents in the established chat based interface sessions to identify intents of the clients with respect to the operation of the portion of the infrastructure and vest authority in the functionality customized agentic agents to make changes to the operation of the portion of the infrastructure based on the intents.

In an embodiment, a non-transitory media is provided that may include instructions that when executed by a processor cause any of the above noted methods to be performed.

In an embodiment, a data processing system is provided that may include the non-transitory media and a processor, and may perform any of the above noted methods when the computer-instructions are executed by the processor.

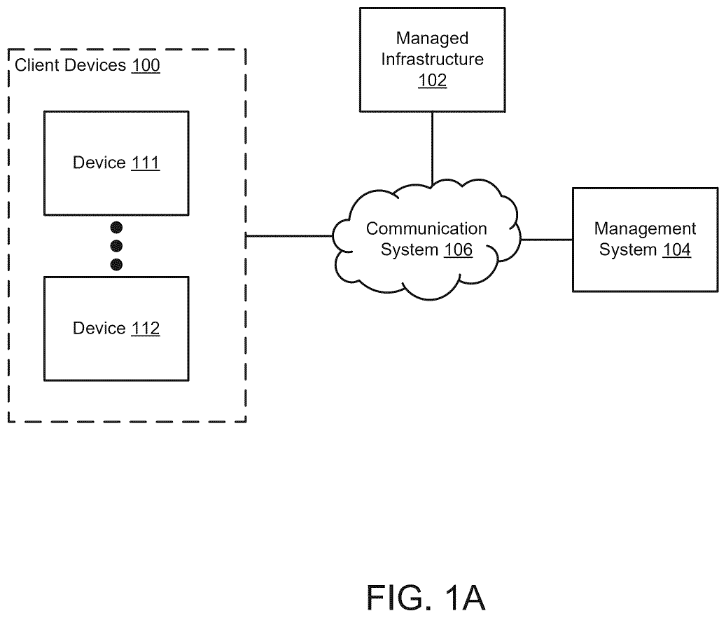

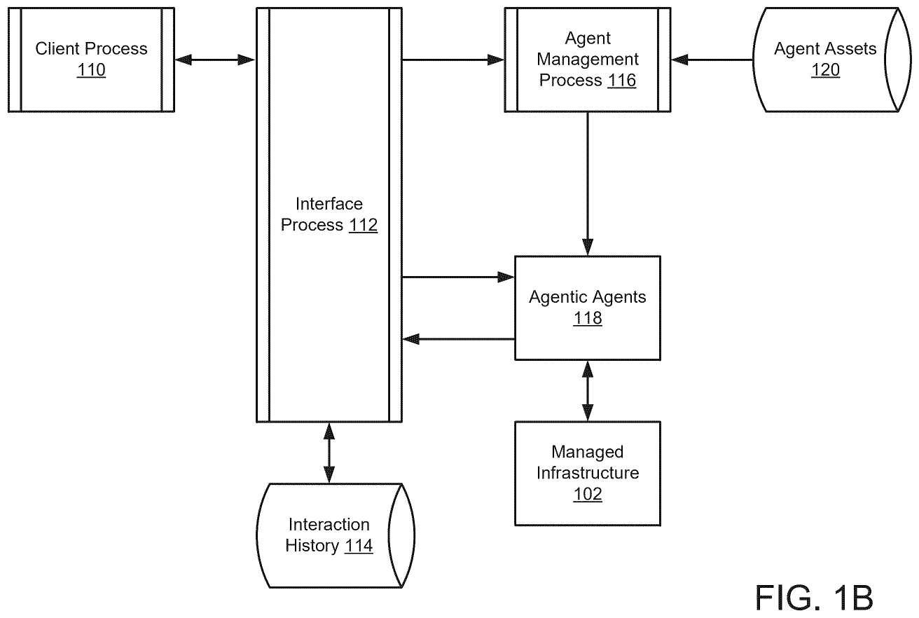

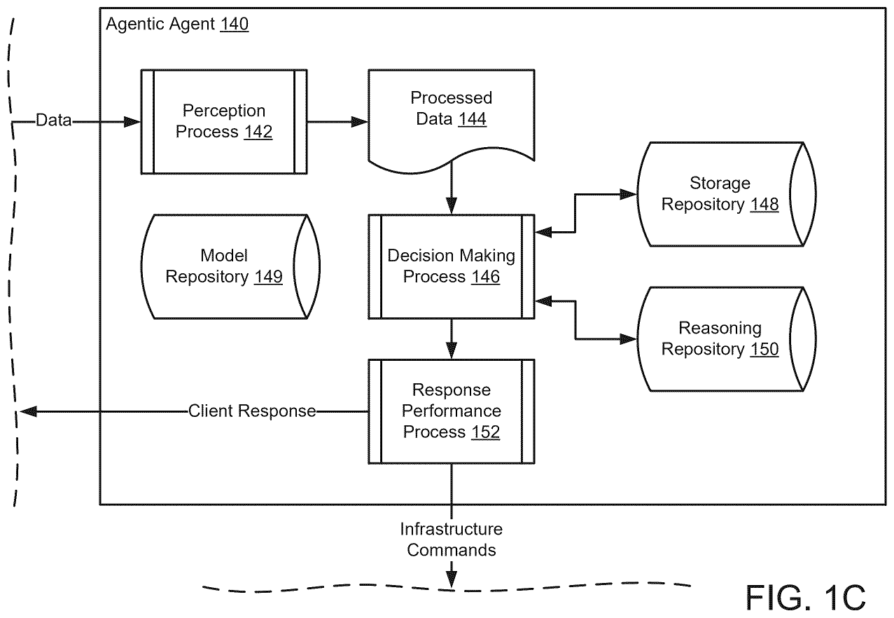

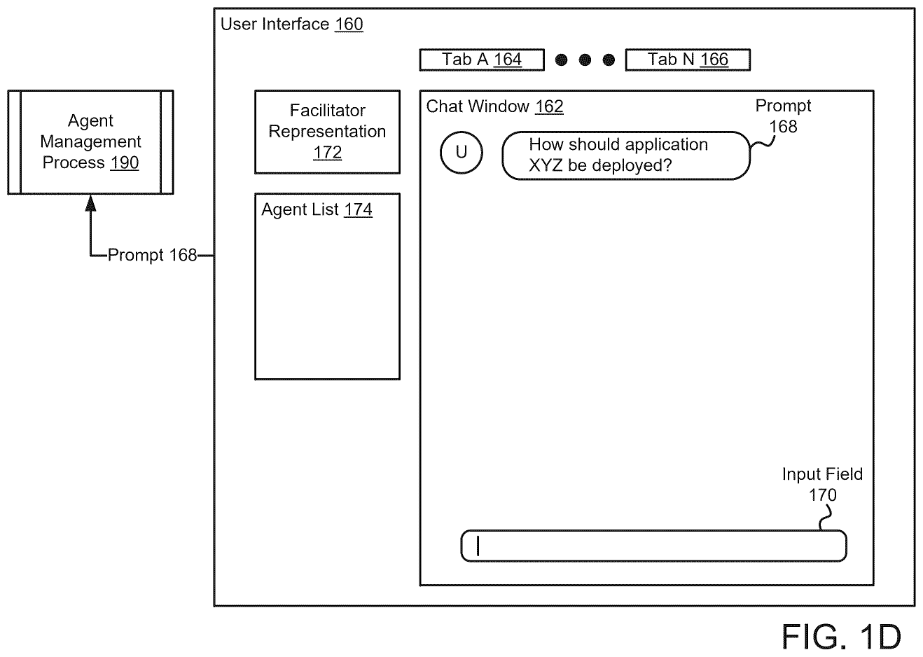

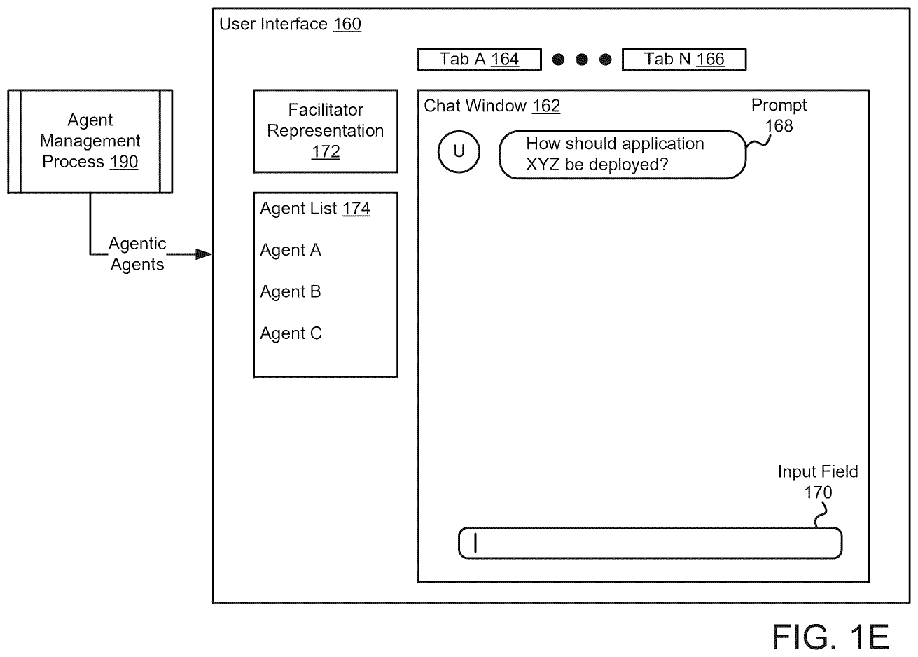

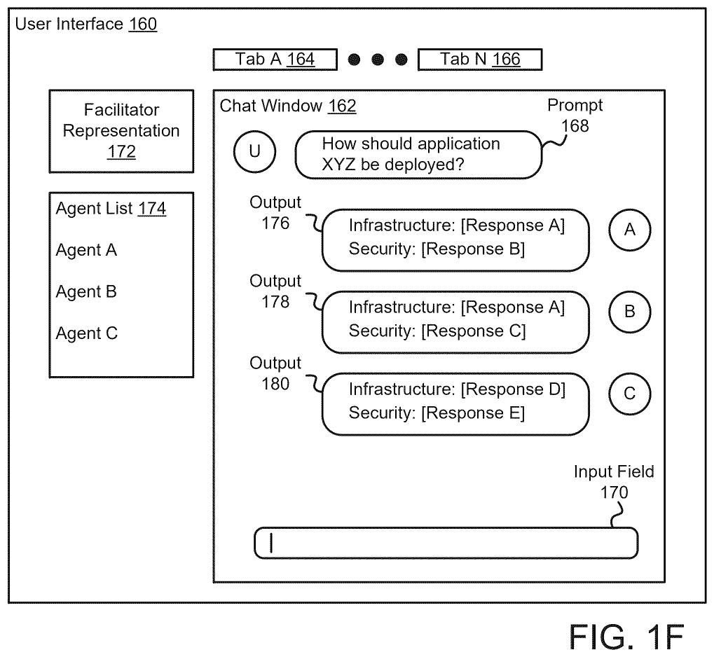

Turning to FIG. 1A, a block diagram of a system in accordance with an embodiment is shown. The system may provide any number and type of computer implemented services.

The computer implemented services may include, for example, database services, data processing services, communications, and/or other types of services. Any of the components of the system of FIG. 1A may provide all, or a portion, of the computer implemented services independently and/or in cooperation with other components of the system.

For the computer implemented services provided by the system of FIG. 1A to be deemed to be desirable by users (e.g., computer programs, persons, etc.) of the computer implemented services, the computer implemented services may need to meet various requirements (e.g., timeliness, accuracy, cost, etc.) and may need to be provided in certain manners (e.g., complete objectives). These requirements and manners may be indicated, for example, by users of the computer implemented services.

To ensure that the computer implemented services meet the requirements and manners of provisioning so that they are (or at least more likely to be) deemed to be desirable, the system of FIG. 1A may configure itself in a corresponding manner. For example, various pieces of software may be deployed, configurations of the software and/or hardware components may be set, various resources of the system may be reserved for contributing to the services, etc.

However, if the aforementioned configuration of the system of FIG. 1A is not successfully completed, then the computer implemented services may be more likely to be deemed to be undesirable. For example, if insufficient resources for providing the computer implemented services are reserved, then the provided computer implemented services may not meet timeliness (e.g., latency) goals. Other issues may impact the computer implemented services if the aforementioned configuration of the system of FIG. 1A is not successfully completed without departing from embodiments disclosed herein.

Further, a mismatch between an intent of the users regarding the computer implemented services and an understanding of the intent by the system of FIG. 1A may also reduce the likelihood of the computer implemented services being deemed to be desirable. For example, if a user only partially conveys an intent by making a tacit statement (e.g., a partial but incomplete statement of intent) regarding the computer implemented services to be provided, then the system may not successfully a corresponding configuration necessary to provide the computer implemented services in a manner that meets that actual intent of the users.

Additionally, if a mismatch between an understanding of the users regarding future operation of the system of FIG. 1A and the actual likely future operation of the system may further reduce the likelihood of the computer implemented services being deemed to be desirable. For example, the users may have limited knowledge regarding how configurations of the system are likely to impact the provided computer implemented services. Consequently, even if informed of a configuration for the system (e.g., in scenarios where users or other persons establish the configuration), the users may incorrectly identify how the computer implemented services will be provided under that configuration (e.g., the users may expect the computer implemented services to meet different requirements and/or be provided in different manners). Accordingly, the actual computer implemented services may be less likely to meet the users' expectations thereby causing the actually provided computer implemented services to be less likely to be deemed to be desirable.

In general, embodiments disclosed herein relate to systems, methods, and devices for improving the likelihood of computer implemented services provided by systems meeting the expectations of requestors of the services (e.g., being deemed to be desirable). To improve the likelihood of the computer implemented services being deemed to be desirable, an agentic agent based framework may be used to manage the operation of the system. The agentic agent framework may facilitate (i) domain customization and deployment of domain customized agentic agents, (ii) chat based interactions between the domain customized agentic agents and users of the system, (iii) user intent identification and confirmation for the computer implemented services, (iv) cooperative analysis and decision making among the agentic agents, and/or (v) management of infrastructure by the domain customized agentic agents.

By doing so, embodiments disclosed herein may improve the likelihood of computer implemented services provided by a system being deemed desirable by the users for which the services are provided. Thus, embodiments disclosed herein may address, among others, the technical problems of (i) misinterpretation of requests and/or intent in distributed system, (ii) limited technical knowledge of users of the system that may preclude (or limit the ability of) the users from making configuration decisions that are likely to effectuate their intent, and (iii) system configuration drift that may preclude (or limit the ability of) the system to provide desirable computer implemented services.

To provide the above noted functionality, the system may include any number of client devices 100, managed infrastructure 102, management system 104, and communication system 106. Each of these components is discussed below.

Client devices 100 may be used by users (e.g., employees of a business, administrators, computer programs hosted by client devices 100, etc.) to manage and/or obtain computer implemented services provided by/from managed infrastructure 102. To do so, client devices 100 may host interfaces usable to communicate with managed infrastructure 102 and/or management system 104. For example, the interfaces may include chat interfaces through which chat sessions managed by management system 104 may be reached by the users. Client devices may include any number of such devices (e.g., 111, 112) used by any number of users.

Managed infrastructure 102 may provide computer implemented services. To provide the computer implemented services, managed infrastructure 102 may host automation frameworks usable to deploy software, manage configurations of software/hardware components, and/or otherwise modify the operation of various portions of managed infrastructure 102. All, or a portion, of the functionality of the automation frameworks may be usable by agentic agents managed by management system 104.

The agentic agents may be tasked with (i) collecting information from managed infrastructure 102 (e.g., state information, telemetry, etc.), (ii) interacting with users via the chat sessions, (iii) inferring intents of the users regarding computer implemented services to be provided by managed infrastructure 102, and (iv) modifying the operation of managed infrastructure 102 over time to attempt to effectuate the inferred intents.

Because the chat sessions may be an incomplete description of the intent of the users, information obtained by the chat sessions from the users may be treated as tacit statements (e.g., partial statements that may not be a complete declaration of an intent, may be in conflict with other tacit statements, etc.). The tacit statements may be used to infer the intent of the user over time (e.g., which may update as additional tacit statements are obtained). The inferred intent of the users may then be used to identify a goal state for operation of managed infrastructure 102. Once identified, the goal state may be used to select actions to be performed to modify the operation of managed infrastructure 102 to align the actual state of managed infrastructure 102 with the goal state (e.g., over time).

As part of inferring of the intents of the users, information regarding the actual state of managed infrastructure 102 may also be taken into account. Thus, changes in the actual state of managed infrastructure 102 (e.g., changes in hardware components, changes in deployed software, changes in configurations, changes in conditions impacting managed infrastructure 102, etc.) may also change the inferred intents of the users.

To identify the actions to be performed, a quantification process regarding the intent may be performed. For example, an objective function may be formed and used to evaluate the impact of performance of different actions to modify the state of managed infrastructure 102. In an example, the objective function may be formed using key performance indicators (e.g., service latency, resiliency to cyberthreats, cost of operation, etc.) from the inferred intents. These key performance indicators may be compared to actual key performance indicators of the distributed system to identify the degree (e.g., which may be quantified by the objective function) to which the intents of the users are being effectuated by managed infrastructure 102.

Overtime, the agentic agents may select actions to perform on the basis of attempting to maximize the degree to which the tents of the users are being effectuated by the actual operation of managed infrastructure 102.

Management system 104 may manage the agentic agents in the system. To manage the agentic agents, management system 104 may (i) customize and deploy domain customized agentic agents to facilitate management of managed infrastructure 102 and (ii) manage chat sessions to facilitate interactions between users and the domain customized agentic agents to (a) infer intents of the users, (b) inform the users of likely impacts for different potential changes in configuration of managed infrastructure 102, and/or (c) otherwise facilitate management of managed infrastructure 102.

When providing their functionality, client devices 100, managed infrastructure 102, and/or management system 104 may perform all, or a portion, of the flows and/or methods shown in FIGS. 1B-3B.

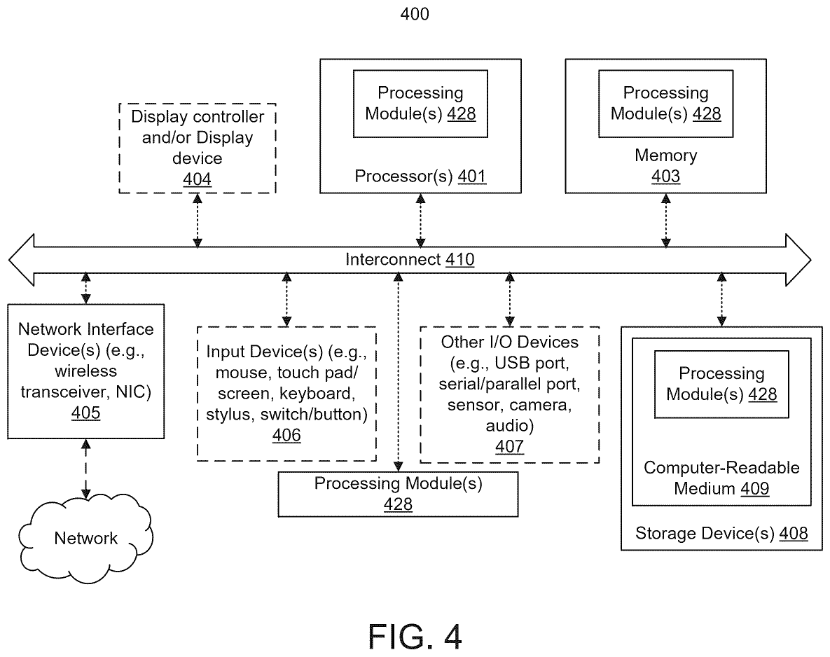

Any of the devices (and/or components thereof) included in the system shown in FIG. 1A may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1A may be operably connected to each other (and/or components not illustrated) with a communication system (e.g., 106). In an embodiment, this communication system includes one or more networks that facilitate communication between any number of components (e.g., including others not shown in FIG. 1A). The networks may include wired networks and/or wireless networks (e.g., and/or the Internet). The networks may operate in accordance with any number and types of communication protocols (e.g., such as the internet protocol).

While illustrated in FIG. 1A as including a limited number of specific components, a system in accordance with an embodiment may include fewer, additional, and/or different components than those illustrated therein.

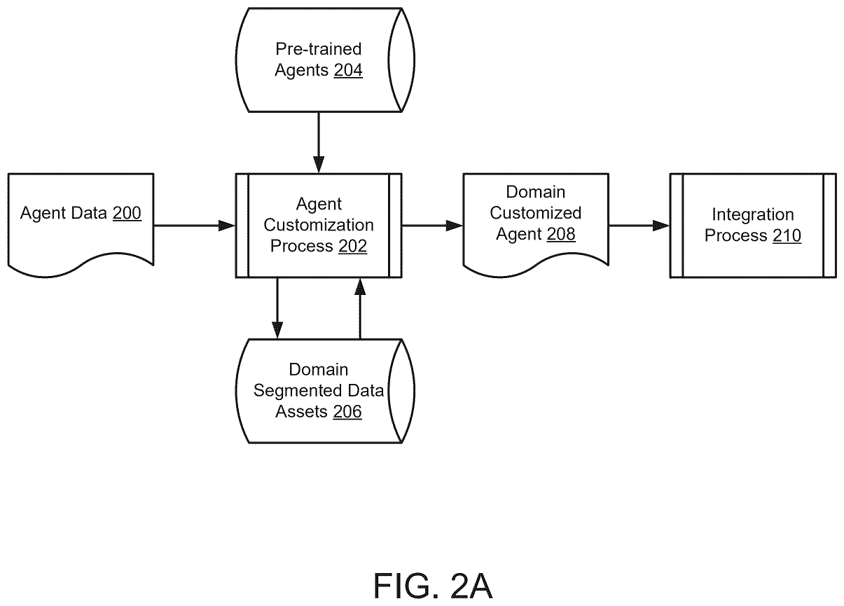

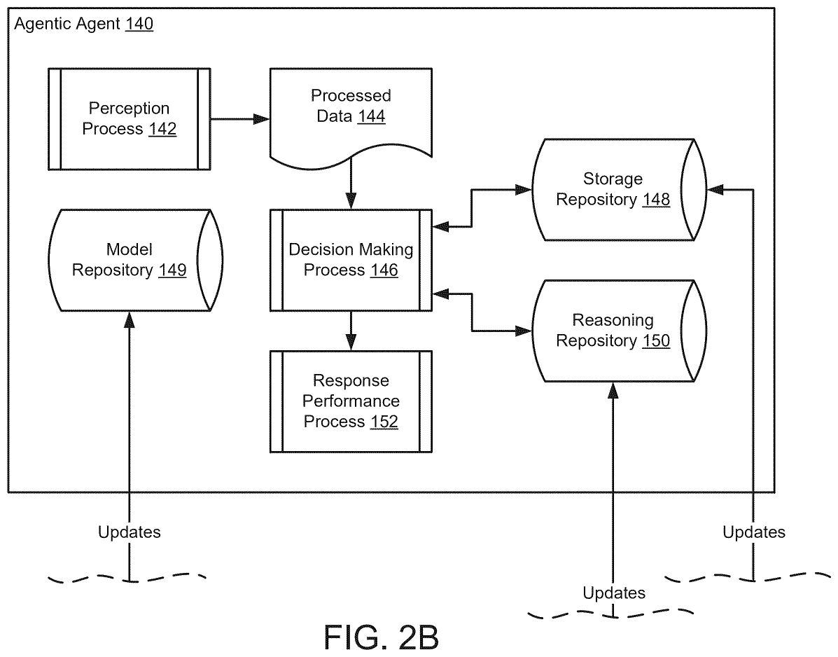

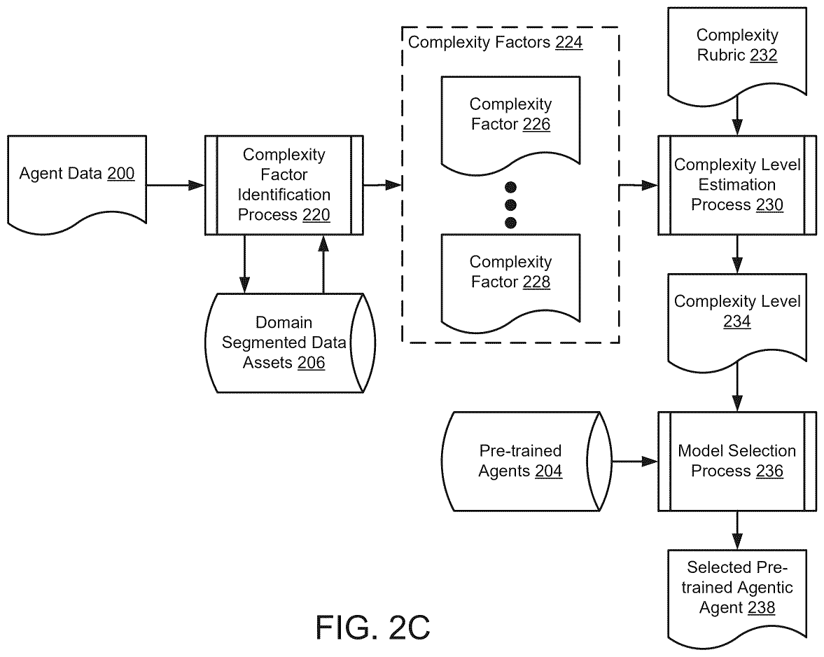

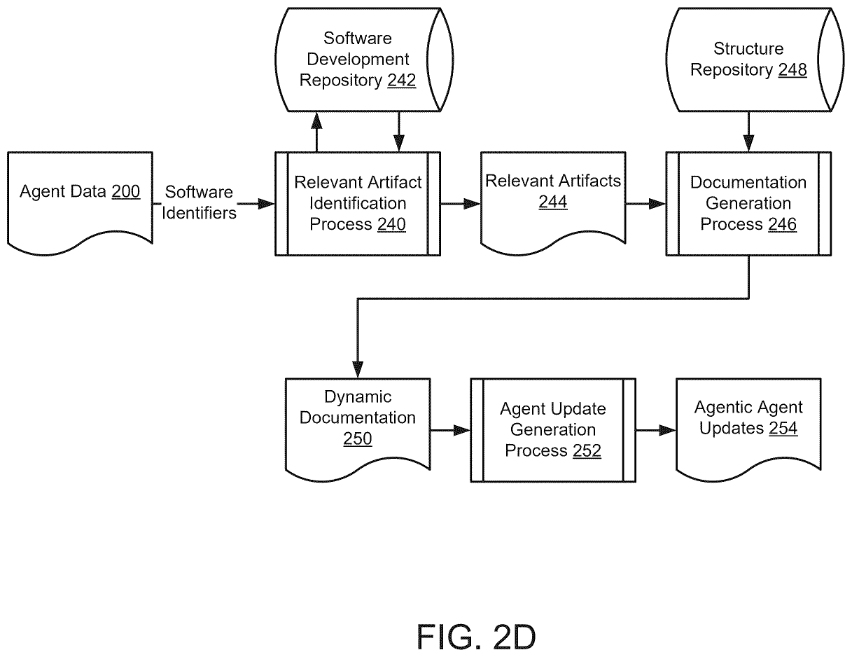

To further clarify embodiments disclosed herein, data flow diagrams in accordance with an embodiment are shown in FIGS. 1B-2B. These data flow diagrams may illustrate how data may be obtained and used within the system of FIG. 1A.

In the data flow diagrams, flows of data and processing of data are illustrated using different sets of shapes. In the context of these data flow diagrams, a first set of shapes (e.g., 144, 200, etc.) is used to represent data structures, a second set of shapes (e.g., 110, 112, etc.) is used to represent processes performed using and/or that generate data, and a third set of shapes (e.g., 114, 120, etc.) is used to represent large scale data structures such as databases.

Turning to FIG. 1B, a first data flow diagram in accordance with an embodiment is shown. The first data flow diagram may illustrate data used in and data processing performed in management of managed infrastructure.

To manage the manage infrastructure, a user may use a client device to perform client process 110. During client process 110, a management request may be sent to the management system. Based on the request, the management system may initiate performance of interface process 112.

During interface process 112, a chat session between the user and the management system may be initiated. The corresponding client process (e.g., 110) may obtain user input and direct it to the chat session managed by interface process 112. Refer to FIGS. 1D-1F for additional information regarding how the chat session may be performed.

During the chat session, information may be conveyed by the user regarding a goal, desire, requirements, and/or other characteristic of computer implemented services to be provided by managed infrastructure 102. The information may be used to identify (i) new agentic agents to be instantiated to assist in accomplishing the intent of the users, and/or (ii) new and/or existing agents to invite to chat session. The agents may be identified, for example, based on a prompt or other information provided by the users. Once identified, the agentic agents may participate in the corresponding chat session.

To instantiate new agentic agents, agent management process 116 may be performed. During agent management process 116, information regarding domains of expertise for an agent may be obtained. The identified domains may be used to discriminate relevant information from agent assets 120. Agent assets 120 may include any type and quantity of information usable to customize an agentic agent for a particular domain. Once obtained, the agentic agent may be customized for the domain (e.g., type of environment in which infrastructure that will be managed by the agent will reside, the particular goal or competency that the agent is desired to have, etc.) and then deployed. Refer to FIGS. 1C and 2A-2B for additional information regarding customization of agentic agents for domains.

The resulting agentic agents may be customized for different operating environments such as, for example, a data center environment; a telecommunications computing environment; an edge computing environment; a cloud computing environment; a backup computing environment; an artificial intelligence environment; a co-located computing environment; and a storage computing environment. The agentic agents may also be customized for different domains of expertise of capabilities such as, for example, security; performance; data protection; resource management; health; and sustainability.

To perform the customization, agent assets 120 may include various types of information usable to customize the operation of, for example, generative artificial intelligence processes performed by, for example, large language models or other types of generative inferencing models used by the agentic agents. For example, agent assets 120 may include documentation for the infrastructure, software hosted by the infrastructure, testing performed for the infrastructure, support tickets for the infrastructure and corresponding resolution processes performed to address the issued indicated by the support tickets, telemetry data for operation of the infrastructure (and/or simulations of the infrastructure, such as digital twins), logs of operation of the infrastructure, etc.

The content of agents assets 120 may be pre-segmented or dynamically segmented with respect to the different domains (e.g., computing environment, competency/concern, etc.) to which the agentic agents may be customized. The content may be segmented with respect to relevancy for these different domains. The segmentation may be performed via any method. For example, a large language model may be used to process different portions of the content and classify it with respect to levels of relevancy, natural language processing and grading rubrics for relevancy may be used, subject matter experts may segment it, etc.

During the performance of interface process 112, information regarding the chat session may be stored in interaction history 114. The information may be used, for example, to document tacit statements made by the users. The tacit statements may be subsequently used to derive intents of the users, and select various management actions for performance to update the operation of managed infrastructure 102 over time. Thus, the operation of managed infrastructure 102 may be more likely to be aligned with the intents of the users and thereby provide computer implemented services that are more likely to be deemed to be desirable by the users.

Turning to FIG. 1C, a second data flow diagram in accordance with an embodiment is shown. The second data flow diagram may illustrate data used in and data processing performed in operation of agentic agents deployed in the system of FIG. 1A.

During operation, agentic agents may include various components that facilitate autonomy and decision making to manage various aspects of the operation of managed infrastructure. For example, an agentic agent may include tool layers that facilitate access and use of external entities to obtain information and drive external processes, reasoning layers to analyze the obtained information using, for example, large language models or other types of generative trained machine learning models, action layers to facilitate interactions between the agentic agents and external entities, and/or other layers.

To implement a tool layer, agentic agent 140 may perform perception process 142. During perception process 142, various types of data may be obtained from remote entities. The data may include, for example, information regarding the state of managed infrastructure, information from other agentic agents, communications of users and/or other entities participating in chat sessions, etc. Once obtained, the obtain data may be processed to obtain processed data 144.

To implement a reasoning layer, agentic agent 140 may perform decision making process 146. As part of decision making process 146, various reasoning algorithms from reasoning repository 150 may be performed, various portions of data may be stored in storage repository 148 for future use and existing information from storage repository 148 may be obtained, various models (e.g., large/small language models) from model repository 149 may be used, and/or other processes may be performed.

For example, a reasoning algorithm such as chain of thought from reasoning repository 150 may be performed. As part of the reasoning algorithm, various calls may be made to the language models from model repository 149 may be made to process various portions of processed data 144 (e.g., which may include text from a chat session, may be used as a prompt). The language models, in turn, may make various calls to data structures stored in storage repository 148 operating as pre-inference information retrieval sources for retrieval augmented generation (RAG). The resulting inferences from the language models may be used to drive the operation of the reasoning model to obtain various outcomes and store various portions of information in storage repository 148 for future use.

To implement an action layer, agentic agent 140 may perform response performance process 152. During response performance process 152, the outcomes obtained from the reasoning process may be used to invoke functionality of various other entities such as to, for example, send responses to chat sessions and modify the operation of the managed infrastructure. For example, when participating in a chat session, text from a user may be processed as a prompt by the agentic agent which may in turn generate a client response and/or initiate performance of an infrastructure command to modify the operation of the managed infrastructure. The infrastructure command may be processed by an automation framework of the managed system, and cause corresponding actions to be performed by the managed infrastructure. For example, the infrastructure command may be to change a configuration setting, remove/add/modify software, disable/enable various hardware components, etc.

Turning to FIG. 1D, a third data flow diagram in accordance with an embodiment is shown. The third data flow diagram may illustrate data used in and data processing performed in chat sessions used to manage the managed infrastructure.

When a client process reaches out to the management system, an agent management process (e.g., 190) may be performed. During the agent management process, a chat session may be initiated to facilitate interactions between users and agentic agents that manage portions of managed infrastructure.

It will be appreciated that the chat session may include various exchanges and storages of information temporally over time between various participants of the chat session. To facilitate understanding of the chat session, a user interface (e.g., 160) may be presented to a user participating in the chat session. User interface 160 may be a graphical user interface usable to represent how the user and other entities are participating in the chat session. User interface 160 may include, for example, tabs (e.g., 164-166), chat window 162, facilitate representation 172, and agent list 174. Each of these components is discussed below.

Tabs 164-166 may be graphical representations of different chat sessions that the user is participating in at any point in time. For example, during a duration of a chat session, a tab may exist. To page through the different chat session, the user may select corresponding ones of the tabs. When so selected, chat window 162, facilitate representation 172 and agent list 174 may be updated to reflect the chat session selected by the user.

Chat window 162 may be a graphical representation of contributions to a chat discussion made by the user and other entities. For example, chat window may include an input field (e.g., 170) through which the user may provide user input. The user input may be treated, for example, as prompt (e.g., 168) or other type of statement for processing.

For example, when a chat session is initially established, the user may enter text which may be processed as a prompt to attempt to identify agentic agents to participate in the chat session. In the context of a prompt such as “How should application XYZ be deployed”, the prompt may be processed using a large language model (or other type of analysis) to identify which agentic agents are likely to positively contribute to a discussion regarding the prompt (e.g., in the context of the managed infrastructure). The aforementioned prompt may result in the identification that new agentic agents should be instantiated due to the domains indicated by the prompt, and identification of existing agentic agents that are to participate in the discussion (e.g., on the basis of relevancy to the domains). As noted above, each customized agentic agent may be customized for a subset of domains (e.g., computing environment, competency, etc.).

Thus, prompt 168 may be processed by agent management process 190 which may in turn instantiate and/or connect various agentic agents to the chat session.

To inform the user of participants in the discussion, facilitate representation 172 may be graphical representation of a facilitator (e.g., an agentic agent, or other type of computerized entity) participating/guiding the discussion.

Likewise, to inform the user of the agentic agents, agent list 174 may include representations of the agentic agents that are participating in the discussion. In the example illustrated in FIG. 1D, no representations are included in agent list 174 because no agentic agents have joined the chat session.

Turning to FIG. 1E, a fourth data flow diagram in accordance with an embodiment is shown. The fourth data flow diagram may illustrate data used in and data processing performed in chat sessions used to manage the managed infrastructure.

Once agentic agents have joined the chat session, as shown in FIG. 1E, identities/representations of the agentic agents may be added to agent list 174. In this example, Agent A, Agent B, and Agent C are used. However, it will be appreciated that icons or other types of graphical elements may be used to convey to the user which agents are participating in the chat session.

Turning to FIG. 1F, a fifth data flow diagram in accordance with an embodiment is shown. The fifth data flow diagram may illustrate data used in and data processing performed in chat sessions used to manage the managed infrastructure.

Once agentic agents have joined the chat session, the agentic agents may independently and/or in cooperation participate in the chat session by, for example, generating output (e.g., 176-180) based on portions of the chat. The agentic agents may do so, for example, using their reasoning logic and language models. The output may be of any type and form. However, as discussed above, each of the agents may be customized for different domains. Consequently, the content of the responses generated by the respective agents may be different and aligned with the respective competency domains of the respective agents.

The chat session may then progress with the user adding addition information via input field 170 to the chat and the agentic agents participating in the chat generating corresponding responses.

Overtime, the agentic agents may process the chat to generate proposed tacit statements regarding an intent of the user. These statements may be presented as an output to the user, and the user may confirm, modify, or deny acceptability of the tacit statements. When a tacit statement is confirmed, the confirmed tacit statement may be stored as part of the corpus of knowledge used to infer the intent of the user.

The agentic agents may then act on the inferred intent of the user, as discussed above.

Turning to FIG. 2A, a sixth data flow diagram in accordance with an embodiment is shown. The sixth data flow diagram may illustrate data used in and data processing performed in managing agentic agents.

To manage agentic agents, agentic agents may be instantiated over time in response to occurrences of agent instantiation events. The agent instantiation events may be, for example, (i) identification of infrastructure (that is not managed with agentic agents) to manage, (ii) obtaining of requests regarding services to be provided by managed infrastructure, (iii) changes in managed infrastructure (e.g., which may change an environment type, management needs of the infrastructure, etc.), and/or other type of events that may indicate that agentic agents are to be instantiated to assist in management of infrastructure.

To instantiate an agentic agent, agent customization process 202 may be performed. During agent customization process 202, agent data 200 may be obtained. Agent data 200 may include any type and quantity of information usable to identify domains (e.g., system domain which may relate to the environment in which managed infrastructure resides, logical domain which may relate to a desired competency for the agent, etc.) for the agentic agent. Agent data 200 may be obtained, for example, (i) from users which may provide it via a chat session, (ii) from storage (e.g., different types of infrastructures may be associated with different types of agents and/or different numbers of agents, may be based on historic data, subject matter expert provided information, etc.), and/or via other methods.

For example, when a user initiates a chat session, the user may input free text. The free text may be obtained and used to obtain agent data 200. Any type of analysis process may be used to identify (i) domains for agents, and (ii) numbers of agents.

Once the domains are identified, a base agent may be obtained from pre-trained agents 204. Pre-trained agents 204 may include any number of agentic agents that are pre-trained for different domains. The pre-trained agents 204 may include (i) large language models, (ii) reasoning models, (iii) data sources (e.g., for RAG), and/or other components. These components of the pre-trained agents may be trained/populated generally for the domains of the agentic agent (e.g., compute domain+competency domain such as edge+cost, data center+performance, etc.). To do so, large volumes of training data from large numbers of infrastructure instances may have been collected and used in the training to generalize the capabilities of the agentic agents.

The base agent may be selected by discriminating it using the domains identified from agent data 200. For example, each agentic agent of pre-trained agents 204 may be associated with respective domains, and the associations may be used to discriminate one that best fits the domains for the new agentic agent.

In addition to base agents (e.g., pre-trained agents) trained for different domains, different agents having different capabilities for each domain may be available. The different capabilities may relate, for example, to the complexity of the language models (e.g., model size), the complexity of the reasoning models, and/or other capabilities. Generally, increased levels of capabilities may be associated with higher resource usage and cost. To reduce the resource usage and/or cost, a base model may also be selected on the basis of the level of capabilities needed. Refer to FIG. 2C for additional details regarding how the level of capabilities needed for an agentic agent may be identified and used to select one of the base agents.

Once the base agent is obtained, the base agent may be customized. To customize the base agent, the large language models, reasoning models, and/or data sources may be updated using a portion of domain segmented data assets 206. The domain segmented data assets may be segmented portions of the information from agent assets 120 for different domains. The segmentation may be used to discriminate relevant portions of the information. The information may be pre-segmented, or dynamically segmented using any segmentation process.

Once discriminated, the portion of the information may be used to, for example, refine the large language models, modify operation of the reasoning models, and/or supplement the data sources. For example, domain segmented data assets 206 may include information not used in creation of pre-trained agents 204. The information may include user specific information such as, for example, policies of an organization to which the user belongs, organization specific test results, organization specific documentation, etc.

The updating of the base agent may result in the creation of domain customized agent 208. The aforementioned agent customization process may be repeated to obtain any number of domain customized agents (e.g., for similar or different domains).

In addition to customizing the agent for a particular domain, the pre-trained agent may also (or alternatively) be customized for particular functionality. Refer to FIG. 2D for additional information regarding customizing a pre-trained (or domain customized) agentic agent for particular functionalities.

Once obtained, integration process 210 may be performed. During integration process 210, instances of the domain customized agents may be instantiated, the instances may be given authority over corresponding managed infrastructure, and the instances may be made discoverable (e.g., so that they can be identified and brought into chat sessions, a registry or dynamic process may be used for discovery purposes).

Once complete, the instances of the domain customized agents may be brought into chat session and manage infrastructure.

Turning to FIG. 2B, a seventh data flow diagram in accordance with an embodiment is shown. The seventh data flow diagram may illustrate data used in and data processing performed in customizing agentic agents for different domains.

To customize the agentic agents, as discussed above, information usable to customize the agentic agents may be obtained. Once obtained, various updates may be made to an agentic agent (e.g., 140).

For example, the information may be used to fine-tune operation of one or more large language models. To do so, training cycles using the information may be performed to update the weights and/or other architectural features of the large language models.

In some embodiments, agentic agents may include task-specific large language models. In those cases, multiple large language models (or small language models or other types of models) may be updated through fine-tuning to provide for task specific domain inferencing.

For example, the agentic agents may be pre-trained to perform generalized (i) monitoring of infrastructure, (ii) planning, (iii) troubleshooting such as root cause analysis and/or remediation of root cause issues, (iv) optimization for particular goals for infrastructure, (v) self-learning over time, (vi) business analysis, (vii) detection of issues, (viii) auditing, (ix) financial analysis such as billing, and/or other tasks. The fine tuning may align the manner in which these tasks are performed with particular domains.

Like updating of the models, similar updating may be performed for the reasoning models stored in reasoning repository 150. Any reasoning model refinement process may be performed to update the reasoning models.

Lastly, data sources used to provide context for the agentic agents may be updated by supplementing them with the domain specific information. For example, RAG repositories stored in storage repository 148 may be supplemented through addition of all, or a portion, of the domain specific information and/or derived information from the domain specific information.

Turning to FIG. 2C, a seventh data flow diagram in accordance with an embodiment is shown. The seventh data flow diagram may illustrate data used in and data processing performed in selecting of a base agent (e.g., a pre-trained agent) for customization.

To select the base agent, complexity factor identification process 220 may be performed. During complexity factor identification process 220, agent data 200 may be used to identify the data assets of domain segment data assets 206 usable to customize an agent for the domains indicated by agent data 200.

Once identified, complexity factors 224 for the identified data assets may be generated. The complexity factors (e.g., 2240) may be quantifications regarding the relative complexity of the data assets available to customize an agentic agent. Generally, more available data assets of more dense information may require a pre-trained agent with a higher level of capabilities (e.g., larger language models of higher capability pre-trained agents may be better able to integrate the information included in such data assets, reasoning models may similarly need to be of higher complexity to integrate the data assets).

To identify the assets, the assets may be analyzed to identify (i) numbers of topics present in the identified data assets, (ii) complexity of ontology used in the identified data assets, (iii) complexity of interconnectedness of topics of a topic graph based on the identified data assets, (iv) complexity of actions space indicated by the identified data assets, and/or other quantifications for the quantity and complexity of information included in the identified data assets. Any of these and others analysis results may be complexity factors (e.g., 226-228).

For example, the complexity of the ontology may be identified by extracting ontology terms from the identified data assets (e.g., may be done using supervised or unsupervised learning, or other processes), identifying a structure of the ontology terms and using the structure to quantify the complexity (e.g., more branching may be more complex), identifying average (or other statistical characterizations of) level of similarity between parent and child ontology terms in the ontology, etc. Similarly, to identify the complexity of the topic interconnections, once the topic graph is generated, the average distance between nodes in the graph may be measured and divided by, for example, the graph size (or a value derived from the graph size, such as a logarithmic of the graph size), etc.

The action space may be identified, for example, using natural language processing or large language models to identify potential actions that may be taken in response to various conditions as indicated by the identified data assets (e.g., a support ticket and corresponding resolution may identify such a relationship, the action space may be the aggregate of all such relationships indicated by the identified data assets).

Once complexity factors 224 are obtained, complexity level estimation process 230 may be performed. During complexity level estimation process 230, a complexity rubric (e.g., 232) may be used to (i) obtain an overall complexity score for the identified data assets, and (ii) identify a complexity level (e.g., 234) using the overall complexity score. Complexity rubric 232 may specify a process, formula, algorithm, or other information usable to combine complexity factors 224 to obtain an overall complexity score. The overall complexity score may then be used to obtain complexity level 234, through use of a formula or other relationship defined by complexity rubric 232. For example, complexity factors 224 may be combined using a weighted sum defined by complexity rubric 232 to obtain the complexity score. The complexity score may then be used as complexity level 234, or may otherwise be used (e.g., as input to a function or some other type of relation) to obtain complexity level 234.

Once complexity level 234 is obtained, model selection process 236 may be performed. During model selection process 236, one of the pre-trained agents from pre-trained agents 204 may be selected that (i) is trained with respect to the domains indicated by agent data 200, and (ii) is indicated as desirable by complexity level 234. For example, all of the pre-trained agents for a given domain may each be assigned a complexity score range (e.g., different pre-trained agents having different ranges). The pre-trained agent associated with the range in which complexity level 234 falls may be selected.

It will be appreciated that other information may be taken into account during model selection process 236, which may cause the selection process to change. For example, desired computational or economic costs may also be taken (e.g., may cause certain pre-trained agents to be excluded from consideration, may be used to modify the ranges ascribed to the models, etc.). Thus, complexity level 234 may serve as a basis but may not necessarily be outcome determinative in selection of the pre-trained model.

The resulting selected pre-trained agentic agent 238 may then be updated using the identified data assets, as discussed with respect to FIGS. 2A-2B.

Turning to FIG. 2D, an eighth data flow diagram in accordance with an embodiment is shown. The eighth data flow diagram may illustrate data used in and data processing performed in customizing an agentic agent (pre-trained, domain customized, etc.) for particular functionalities.

When an agentic agent is to be tasked with managing infrastructure, the agentic agent may lack (e.g., may not be trained or have information to do) sufficient ability to perform one or more functionalities that existing software is able to perform (and/or insufficient existing documentation regarding the functionality may exist). For example, in addition to system and logic domain information, agent data 200 may also identify (directly or indirectly) functionality of software which the agentic agent should have capabilities to perform (e.g., independently, or invoke through the software).

Additionally, the particular functionality may be identified based on data assets identified to be used in customizing the agentic agent. For example, the data assets identified to customize the agentic agent may reference or otherwise indicate functionalities of particular software. If a pre-trained agentic agent lacks competencies with respect to these functionalities, then the software and corresponding functionalities may be identified.

To customize an agentic agent with respect to the functionality of the software, relevant artifact identification process 240 may be performed. During relevant artifact identification process 240, software development artifacts (e.g., relevant artifacts) for the software and/or specific functionality of the software may be obtained from software development repository 242.

Software development repository 242 may include any quantity and type of software development artifacts for any number of pieces of software. The software development artifacts may include, for example, software development goal information; production code for the software; code development organizational information; test code used to test the software; test plans defining how the software is to be tested; artifacts produced during testing of the software using the test code and the test plans; software product integrated organizational information; and/or other types of artifacts for the software. The artifacts may be organized in any manner to facilitate identification of artifacts that are relevant to corresponding software and functionalities of the software.

The resulting relevant artifacts 244 may be used to drive documentation generation process 246. During documentation generation process 246, the relevant artifacts may be processed to generate user readable (or other types) of documentation regarding (i) the software, and/or (ii) functionalities of the software. For example, the resulting dynamic documentation 250 may be arranged to cover topics of interest such as the functionalities indicated by agent data 200. Structure repository 248 may include templates, rules, and/or other information defining how to arrange and integrate content from relevant artifacts 244 into dynamic documentation.

For example, a template from structure repository 248 may be used as a base, and a large language model may be used to generate sections of the document using content from relevant artifacts. The large language model may be prompted to generate sections that are (i) relevant to a particular reader, (ii) contextualized for various domains, and/or otherwise adapted for particular use cases. To do so, a prompt library and/or other data structure may be used. The prompts may be derived from historical information (e.g., existing documentation), generated by subject matter experts, or obtained via other processes.

Due to the dynamic nature of the generation process, the resulting dynamic documentation 250 may include up to date information regarding functionalities of the software (e.g., or specific versions of the software, the relevant artifacts may be discriminated based on software version and/or other characteristics such as custom versions).

Once obtained, dynamic documentation 250 may be used during agent update generation process 252 to obtain agentic agent updates 254. During agent update generation process 252, dynamic documentation 250 may be used to obtain updates to large language models, reasoning models, retrieval augmented data sources, and/or other components of agentic agents through fine-tuning, supplementation, and/or other update processes which may enhance the ability of the other components to provide the functionalities of the software (e.g., either alone or through invocation of instances of functionalities of the software).

The resulting agentic agent updates 254 may then be applied to an agentic agent, as discussed with respect to FIGS. 2A-2C. Consequently, the resulting functionality customized agentic agent may be more likely to be able to successfully provide the identified functionalities as part of its operation.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

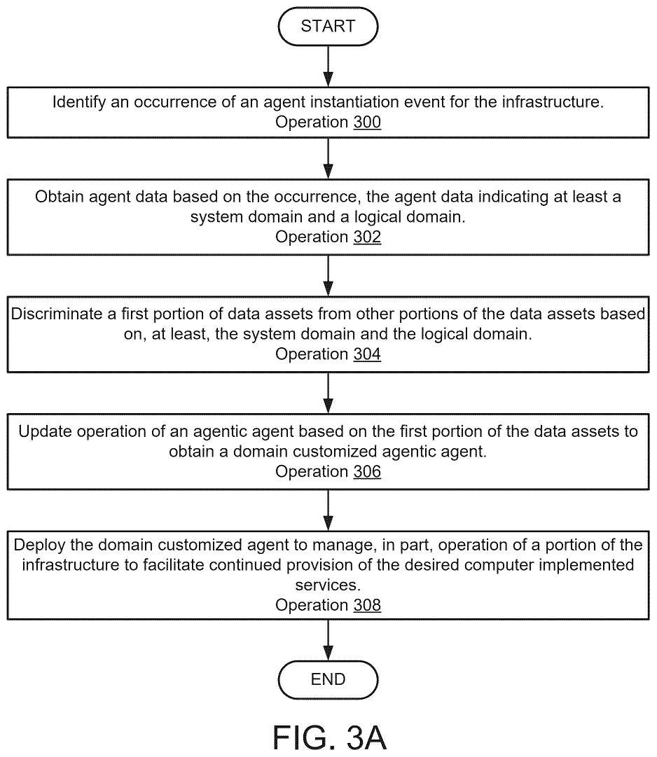

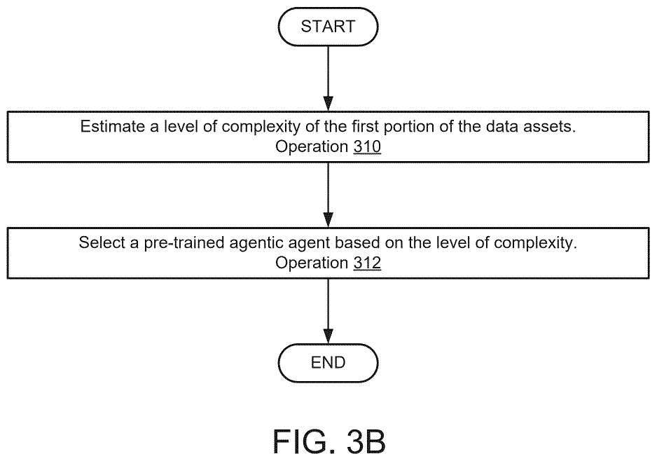

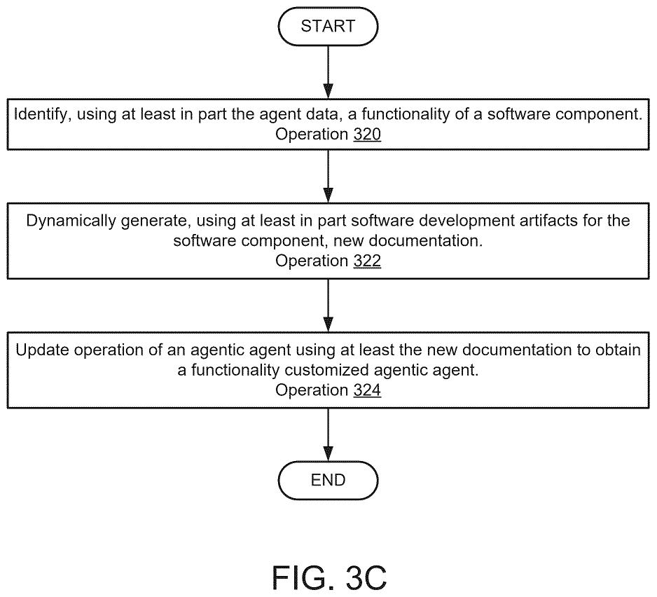

As discussed above, the components of the system shown in FIG. 1A may perform various methods to manage operation of infrastructure. FIGS. 3A-3C illustrate methods that may be performed by the components of the system of FIG. 1A. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for managing infrastructure using agentic agents in accordance with an embodiment is shown. The method may be performed by any of the components of FIG. 1A, and/or other entities without departing from embodiments disclosed herein.

At operation 300, an occurrence of an agent instantiation event for the infrastructure is identified. The agent instantiation event may be, for example, a management request from a client with respect to the portion of the infrastructure. The request may be obtained by receiving it from the client, reading it from storage, generating it, and/or obtaining it via other process.

At operation 302, agent data based on the occurrence is obtained. The agent data may indicate at least a system domain and a logical domain. The agent data may be obtained by reading it from storage, receiving it from another device, generating it (e.g., by processing a prompt or other information from the client or other entity), and/or via other processes.

The system domain may be a type of computing environment in which portion of infrastructure to be managed is located. The system domain may be one selected from a list consisting of: a data center environment; a telecommunications computing environment; an edge computing environment; a cloud computing environment; a backup computing environment; an artificial intelligence environment; a co-located computing environment; and a storage computing environment.

The logical domain may be a management factor (e.g., a domain of competency) for the portion of the infrastructure. The management factor may be one selected from a list consisting of: security; performance; data protection; resource management; health; and sustainability.

In addition to domains, the agent data may also indicate (directly or indirectly) software and/or functionalities of the software desired for an agentic agent to be able to perform and/or use. If not directly indicated, the software and/or software functionalities may be identified based on data assets that are discriminated, as discussed with respect to operation 304. These data assets may reference or otherwise indicate the software and/or software functionalities (e.g., that are relevant for particular domains).

At operation 304, a first portion of data assets from other portions of the data assets is discriminated based on, at least, the system domain and the logical domain. The first portion of the data assets may be discriminated by, for example, using associations between different data assets and the system/logical domains (e.g., the domains may be used as keys to fine the first portion of the data assets), by classifying the data assets with respect to the domains, and/or via other processes.

The data assets may include, for example, documentation regarding the infrastructure, hosted software, support tickets and corresponding resolutions, telemetry from the infrastructure, logs of operation of the infrastructure, client specific information (e.g., internal policies, taxonomies, etc.), and/or other types of data assets that may be used to refine operation of an agentic agent.

Once the first portion of the data assets are discriminated, an agentic agent may be selected based, at least in part, on a level of complexity ascribed to the first portion of the data assets. Refer to operations 310-312 and FIG. 3B for additional information regarding selection of an agentic agent. The operation of the selected agentic agent may then be updated, as discussed below with respect to operation 306.

At operation 306, operation of an agentic agent is updated based on the first portion of the data assets to obtain a domain customized agentic agent. The agentic agent may be updated by performing fine tuning on language models of the agentic agent, updating reasoning models of the agentic agent, populating RAG data sources of the agentic agent, and/or otherwise using the first portion of the data assets to customize the agentic agent to particular domains.

In addition and/or alternatively to customization for domains, the agentic agent may also be customized for functionalities of software. Refer to FIG. 3C for additional information regarding customization of agents for software and/or software functionalities.

At operation 308, the domain customized agent is deployed to manage, in part, operation of a portion of the infrastructure to facilitate continued provision of the desired computer implemented services. The domain customized agent may be deployed by, for example, instantiating an instance of the domain customized agent; operably connecting the instance to a control plane for the portion of the infrastructure to facilitate modification of the operation of the portion of the infrastructure by the instance; and placing the instance in a discoverable state by a facilitator.

The facilitator may be adapted to establish chat based interface sessions for clients (e.g., users) with authority to manage the operation of the portion of the infrastructure and selectively integrate domain customized agents into the established chat based interface sessions. For example, based on a prompt received from a client during a chat based interface session, the facilitator may identify agentic agents that may contribute to a discussion to address the client's prompting.

The facilitator may also be adapted to moderate conversation between the clients and the selectively integrated domain customized agents in the established chat based interface sessions to identify intents of the clients with respect to the operation of the portion of the infrastructure and vest authority in the domain customized agents to make changes to the operation of the portion of the infrastructure based on the intents.

The method may end following operation 308.

Thus, via the method shown in FIG. 3A, embodiments disclosed herein may facilitate management of infrastructure in an automated manner through conversational inferring of intents by domain customized agentic agents.

Turning to FIG. 3B, a second flow diagram illustrating a continuation of the method for managing infrastructure using agentic agents in accordance with an embodiment is shown. The method may be performed by any of the components of FIG. 1A, and/or other entities without departing from embodiments disclosed herein.

At operation 310, a level of complexity of the first portion of the data assets may be estimated. Estimating the level of complexity may include any of (i) identifying a number of topics in the first portion of the data assets, (ii) generating a topic graph based on the topics, and quantifying a level of complexity of interconnections between nodes of the topic graph, (iii) identifying a complexity of ontology used in the first portion of the data assets, (iv) identifying a level of branching of ontology terms in the ontology, and identifying an average level of similarity between parent terms and child terms of the ontology terms, (v) identifying a size of an action space indicated by the first portion of the data assets, and/or via other processes.

The topics in the first portion of the assets may be identified using any topic identification algorithm such as, for example, natural language processing.

The topic graph may be generated using a directed acyclic graph generation algorithm that models the topics and relations between the topics. The level of complexity of the interconnects may be quantified using any quantification algorithm (e.g., level of interconnectedness estimation).

The complexity of the ontology may be identified by using an existing ontology scheme to identify ontology terms that are present, or deriving a new ontology using any ontology derivation algorithm. The level of branching may be identified using any quantification algorithm for branched data structures. The average level of similarity may be identified by, for example, comparing embedding representations of parent/child ontology terms (the relationships may be indicated by an ontology graph, which may be established using any ontology graph generation algorithm). The size of the action space may be identified through natural language, large language model, or other type of processing of the first portion of the data assets.

The level of complexity may be based on topics of the first portion of the data assets, ontology used in the first portion of the data assets, a size of an action space indicated by the first portion of the data assets, and/or other factors.

At operation 312, a pre-trained agentic agent may be selected based on the level of complexity (e.g., and domains expected for a new agentic agent instance). The pre-trained agentic agent may be identified by (i) identifying a size of language model based on the quantified level of complexity of the interconnections, discriminate a portion of pre-trained agentic agents having language models of at least the size, and choosing the pre-trained agentic agent from the portion of the pre-trained agentic agents, (ii) identifying a size of language model based on the complexity of the ontology, discriminating a portion of pre-trained agentic agents having language models of at least the size, and choosing the pre-trained agentic agent from the portion of the pre-trained agentic agents, (iii) identifying a size of language model based on the size of the action space, discriminating a portion of pre-trained agentic agents having language models of at least the size, and choosing the pre-trained agentic agent from the portion of the pre-trained agentic agents, and/or otherwise using the complexity factors to identify one of the pre-trained agentic agents that are trained for the domains of interest.

Selecting the pre-trained agentic agent may include using a grading rubric to identify a minimum model size (and/or other features of an agentic agent) based on the level of complexity, the grading rubric may specify a weighting system for at least the topics, the ontology, and the size to identify the minimum model size.

The method may return to operation 306 following operation 312.

Turning to FIG. 3C, a third flow diagram illustrating a continuation of the method for managing infrastructure using agentic agents in accordance with an embodiment is shown. The method may be performed by any of the components of FIG. 1A, and/or other entities without departing from embodiments disclosed herein.

At operation 320, a functionality of a software component may be identified. The functionality of the software component may, as noted with respect to FIG. 3A, may be identified directly by the agent data (e.g., as part of a request) or indirectly.

For example, the functionality of the software component may be identified by identifying an information content deficiency in the first portion of the data assets (e.g., the discriminated portions discussed with respect to FIG. 3A) relative to the system domain and the logical domain; and searching functionalities of software components to identify that the functionality of the software component is usable to remediate, at least in part, the information content deficiency.

The information content deficiency may be identified by analyzing the first portion of the data assets to ascertain whether a minimum quantity of information regarding the functionality of the software is described (e.g., may be based on reference counts, natural language processing, large language model analysis, etc.). If insufficient information is available, then existing software components and corresponding documentation for the software components may be searched for relevant software artifacts.

Additionally, the functionality of the software component may also identified using associations between the logical domain and/or the system domain to different software components, the software component may be one of the different software components.

At operation 322, new documentation is dynamically generated using, at least in part, software development artifacts for the software component (and/or functionality thereof).

The software development artifacts may include at least one selected from a list consisting of: software development goal information; production code for the software; code development organizational information; test code used to test the software; test plans defining how the software is to be tested; artifacts produced during testing of the software using the test code and the test plans; and software product integrated organizational information.

The new documentation may be dynamically generated by (i) identifying templates, (ii) populating the templates using the software development artifacts (e.g., via natural language processing, prompt base large language model generation, etc.), and/or otherwise using the software development artifacts to dynamically create documentation.

The documentation may be customized, for example, to define how to perform the software functionality, and/or invoke use of the software to have the functionality performed. The documentation may be further customized for the logical domain and system domain.

At operation 324, operation of an agentic agent is updated using at least the new documentation to obtain a functionality customized agentic agent. The agentic agent may be a pre-trained agentic agent, a domain customized agentic agent, etc.

The operation may be updated by, for example, (i) fine-tuning a generative trained machine learning model of the pre-trained agentic agent using the new documentation, (ii) fine-tuning a reasoning model of the pre-trained agentic agent using the new documentation, and/or (iii) populating a data source of the pre-trained agentic agent using the new documentation, the data source used for contextual information retrieval.

The method may end following operation 324.

Thus, when a resulting agentic agent is deployed, the agentic agent may be domain and/or functionality customized.

Embodiments disclosed herein may be implemented with one or more computing devices. Turning to FIG. 4, a block diagram illustrating an example of a data processing system (e.g., a computing device) in accordance with an embodiment is shown.

For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processors can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing infrastructure that provides desired computer implemented services, the method comprising:
identifying an occurrence of an agent instantiation event for the infrastructure;
based on the occurrence:
obtaining agent data based on the occurrence, the agent data indicating at least a system domain and a logical domain;
identifying, using at least in part the agent data, a functionality of a software component;
dynamically generating, using at least in part software development artifacts for the software component, new documentation;
updating operation of a pre-trained agentic agent using at least the new documentation to obtain a functionality customized agentic agent; and
deploying the functionality customized agentic agent to manage, in part, operation of a portion of the infrastructure to facilitate continued provision of the desired computer implemented services.

2. The method of claim 1, further comprising:
discriminating a first portion of data assets from other portions of the data assets based on, at least, the system domain and the logical domain; and
updating operation of the functionality customized agentic agent using the first portion of the data assets so that the deployed functionality customized agentic agent is also customized to the system domain and the logical domain.

3. The method of claim 2, wherein the functionality of the software component is also identified based on the first portion of the data assets.

4. The method of claim 3, wherein identifying the functionality of the software component comprises:
identifying an information content deficiency in the first portion of the data assets relative to the system domain and the logical domain; and
searching functionalities of software components to identify that the functionality of the software component is usable to remediate, at least in part, the information content deficiency.

5. The method of claim 1, wherein the functionality of the software component is also identified using associations between the logical domain and/or the system domain to different software components, the software component being one of the different software components.

6. The method of claim 1, wherein the software development artifacts comprise at least one selected from a list consisting of:
software development goal information;
production code for the software;
code development organizational information;
test code used to test the software;
test plans defining how the software is to be tested;
artifacts produced during testing of the software using the test code and the test plans; and
software product integrated organizational information.

7. The method of claim 1, wherein updating the operation of the pre-trained agentic agent using at least the new documentation to obtain the functionality customized agentic agent comprises:
fine-tuning a generative trained machine learning model of the pre-trained agentic agent using the new documentation.

8. The method of claim 1, wherein updating the operation of the pre-trained agentic agent using at least the new documentation to obtain the functionality customized agentic agent comprises:
fine-tuning a reasoning model of the pre-trained agentic agent using the new documentation.

9. The method of claim 1, wherein updating the operation of the pre-trained agentic agent using at least the new documentation to obtain the functionality customized agentic agent comprises:
populating a data source of the pre-trained agentic agent using the new documentation, the data source used for contextual information retrieval.

10. The method of claim 1, wherein deploying the functionality customized agentic agent comprises:
instantiating an instance of the functionality customized agentic agent;
operably connecting the instance to a control plane for the portion of the infrastructure to facilitate modification of the operation of the portion of the infrastructure by the instance; and
placing the instance in a discoverable state by a facilitator.

11. The method of claim 10, wherein the facilitator is adapted to establish chat based interface sessions for clients with authority to manage the operation of the portion of the infrastructure and selectively integrate functionality customized agentic agents into the established chat based interface sessions.

12. The method of claim 11, wherein the facilitator is further adapted to moderate conversation between the clients and the selectively integrated functionality customized agentic agents in the established chat based interface sessions to identify intents of the clients with respect to the operation of the portion of the infrastructure and vest authority in the functionality customized agentic agents to make changes to the operation of the portion of the infrastructure based on the intents.

13. A non-transitory machine-readable medium having instructions stored therein, which when executed by a processor, cause operations for managing infrastructure that provides desired computer implemented services to be performed, the operations comprising:
identifying an occurrence of an agent instantiation event for the infrastructure;
based on the occurrence:
obtaining agent data based on the occurrence, the agent data indicating at least a system domain and a logical domain;
identifying, using at least in part the agent data, a functionality of a software component;
dynamically generating, using at least in part software development artifacts for the software component, new documentation;
updating operation of a pre-trained agentic agent using at least the new documentation to obtain a functionality customized agentic agent; and
deploying the functionality customized agentic agent to manage, in part, operation of a portion of the infrastructure to facilitate continued provision of the desired computer implemented services.

14. The non-transitory machine-readable medium of claim 13, wherein the operations further comprise:
discriminating a first portion of data assets from other portions of the data assets based on, at least, the system domain and the logical domain; and
updating operation of the functionality customized agentic agent using the first portion of the data assets so that the deployed functionality customized agentic agent is also customized to the system domain and the logical domain.

15. The non-transitory machine-readable medium of claim 14, wherein the functionality of the software component is also identified based on the first portion of the data assets.

16. The non-transitory machine-readable medium of claim 15, wherein identifying the functionality of the software component comprises:
identifying an information content deficiency in the first portion of the data assets relative to the system domain and the logical domain; and
searching functionalities of software components to identify that the functionality of the software component is usable to remediate, at least in part, the information content deficiency.

17. A system, comprising:
a processor; and
a memory coupled to the processor to store instructions, which when executed by the processor, cause operation for managing infrastructure that provides desired computer implemented services to be performed, the operations comprising:
identifying an occurrence of an agent instantiation event for the infrastructure;
based on the occurrence:
obtaining agent data based on the occurrence, the agent data indicating at least a system domain and a logical domain;
identifying, using at least in part the agent data, a functionality of a software component;
dynamically generating, using at least in part software development artifacts for the software component, new documentation;
updating operation of a pre-trained agentic agent using at least the new documentation to obtain a functionality customized agentic agent; and
deploying the functionality customized agentic agent to manage, in part, operation of a portion of the infrastructure to facilitate continued provision of the desired computer implemented services.

18. The system of claim 17, wherein the operations further comprise:
discriminating a first portion of data assets from other portions of the data assets based on, at least, the system domain and the logical domain; and
updating operation of the functionality customized agentic agent using the first portion of the data assets so that the deployed functionality customized agentic agent is also customized to the system domain and the logical domain.

19. The system of claim 18, wherein the functionality of the software component is also identified based on the first portion of the data assets.

20. The system of claim 19, wherein identifying the functionality of the software component comprises:
identifying an information content deficiency in the first portion of the data assets relative to the system domain and the logical domain; and
searching functionalities of software components to identify that the functionality of the software component is usable to remediate, at least in part, the information content deficiency.
